(19) United States
(12) Patent Application Publication
(10) Pub. No.: US 2014/0074554 A1
(43) Pub. Date: Mar. 13, 2014

(54) SYSTEM AND METHOD FOR A TARGET MARKET BUSINESS STRUCTURE

(71) Applicants: Michael W. Warner, San Jose, CA (US); Laurie Elizabeth Warner, San Jose, CA (US); Robert L. Pangburn, San Jose, CA (US)

(72) Inventors: Michael W. Warner, San Jose, CA (US); Laurie Elizabeth Warner, San Jose, CA (US); Robert L. Pangburn, San Jose, CA (US)

(21) Appl. No.: 14/022,005

(22) Filed: Sep. 9, 2013

Related U.S. Application Data
(60) Provisional application No. 61/698,135, filed on Sep. 7, 2012.

(51) Int. Cl. G06Q 30/02; G06Q 20/14

(52) U.S. Cl. CPC G06Q 30/0214; G06Q 20/14; G06Q 30/0205
USPC 705/7.34; 705/14.16

(57) ABSTRACT

This is a system and method for an entity to collect commission payments for sales of goods or services from suppliers. Information regarding the goods or services of the suppliers is compiled and adapted for presentation to target markets by a first server. This adapted information is transmitted to a second server located in the target market which is made available to consumers of the target market by a website controlled by the second server. Consumer queries are received at the website and consumer appointments are made at target market stores associated with the suppliers. These appointments are made to an in store electronic device located in the target market stores. Information regarding consumer purchases are recorded by the in store electronic device, transmitted to the second server, and then commissions are billed accordingly for payment by the suppliers.

### CROSS-REFERENCE TO RELATED APPLICATION

This application claims the benefit of priority from U.S. provisional application No. 61/698,135 filed on Sep. 7, 2012, which is hereby incorporated by reference.

### TECHNICAL FIELD

The invention relates to a system and method of billing a commission for sales of goods and services.

### BACKGROUND

Traditionally, goods and services are sold by suppliers at stores or websites with marketing done through magazines, along with special events, new product introductions, billboards, newspapers, television, Internet and other channels to display them. Goods and services are primarily purchased by customers with at least some knowledge of the goods and services.

Today the growth of new wealth, particularly in economically emerging countries such as China, India, Brazil, etc., has created a new class of consumers who have the desire to possess goods and services but have not had the time to develop the knowledge and appreciation of them. Clearly an unbiased and trustworthy source of information about goods and services is needed by this new group of consumers or any other consumers not knowledgeable about the goods and services they desire which can present this information in a manner that is consistent with the consumer's language, social customs, etc.

At the same time suppliers have been trying to do business in the same manner as they did in their traditional sales channels. They have been opening stores in major markets and using traditional promotional techniques resulting in somewhat of a hit or miss affair with major inefficiencies and disappointing results.

Another problem is that goods are often copied and customers are wary of being tricked or cheated. For example, attempts to utilize the Internet to sell products have been hampered by the ease of shipping cheap counterfeit goods rather than the originals. Also the touch and feel of the goods is missing from the Internet shopping experience. The use of the Internet is becoming a way of doing research prior to making a goods or services purchase. However, a confusing array of goods and services with their product claims crowd the Internet making research and shopping confusing and frustrating. A very easy to use, comprehensive and reliable website containing information on goods and services tailored to specific target markets would be of great use to those doing research or shopping on the Internet.

Traditionally Internet sites collect advertisement revenue from suppliers for posting their product information. This requires the supplier to invest in advertising upfront without a guarantee of sales resulting from the advertisement. A better approach is for a web site company to charge a supplier a commission on the sale of the item first seen on the web site when it is sold in the store or at the supplier's website. This approach is difficult to track and is open to mistakes if a reliable system is not in place to protect the web site company. If the customer goes to the web site and finds an item to purchase and then subsequently makes a purchase in a store or on the luxury goods web site the web site company would get a commission on the sale.

From a business point of view it is often difficult to move money into and out of certain countries due to strict government regulations. A business structure that could allow work to be performed in collaboration between business entities located in different countries each contributing to the total business but minimizing the money flow between companies would help reduce this problem.

Countries have different regulations restricting the out of country transmission of particular types of data. A system that would filter data during data transmission is desired.

Language becomes a barrier to efficient operation along with the accompanying lack of understanding of the cultural and customs. Clearly, a system and method to reliably present information regarding goods and services, tailored to specific target markets is needed.

### SUMMARY

The system and method provides a unique method for collection of commissions on sales of goods or services from suppliers of the goods or services. Information is gathered regarding the offering for sale of goods or services by suppliers of the goods or services and this information is sent to a first server. Once gathered, the information is normalized, and adapted for presentation to a target market utilizing the first server. This adapted information is electronically transmitted over a global network to a second server which is located in a physical location inside the target market, usually the country of the target market. Upon receipt of the adapted data by the second server, the adapted data is made communicable to target market consumers using a website.

The website accepts consumer queries and may respond to the queries by making appointments for the consumers at target market stores (stores located in the target market) that are associated with the suppliers of the goods or services. The appointments are made via the global network to an in store electronic device which is physically located in the target market store.

Information regarding purchases made by consumers at the target market store are recorded by the in store electronic device and transmitted to the second server via the global network. Sales data or other data is transmitted from the second server to the first server. The system filters the data so that only data that is permitted for out of country transfer according to the rules and regulations of the target country is transmitted. Suppliers are then billed for commissions for the consumer purchases at the target market country store.

### BRIEF DESCRIPTION OF THE DRAWINGS

FIG. 1 is a system diagram showing the major components, devices, and electronic communications media used to implement the target market business structure.

FIG. 2 is a block diagram illustrating elements of a target market business structure where the supplier is located outside of a target market country.

FIG. 3 is a block diagram illustrating elements of a target market business structure where the supplier is located within the target market country.

### DETAILED DESCRIPTION

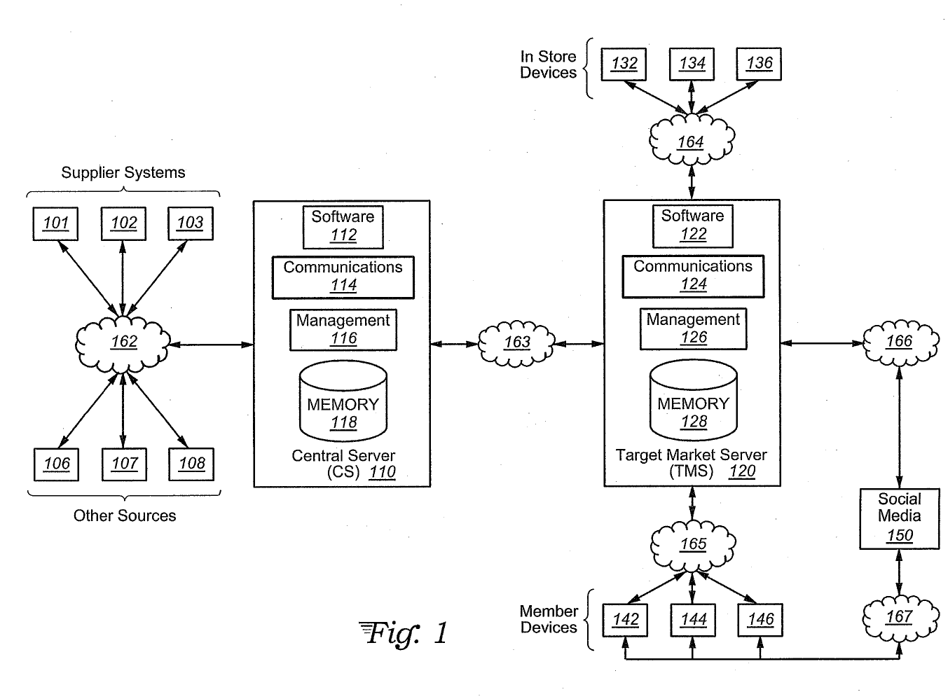

Referring to FIG. 1, there are shown electronic communications media 162, 163, 164, 165, 166, and 167 of which there may be more than six. These electronic communications media may be of various types which include, but need not be limited to the Internet, local area networks, wide area networks, directly hardwired, wireless, satellite, etc. These electronic communications media enable communications between the various systems, servers, and devices shown in FIG. 1 which are all connectable to and can communicate through the electronic communications media.

There are supplier systems 101, 102, and 103 of which there may be more than three and other sources 106, 107, and 108 of which there may also be more than three which communicate via electronic communications medium 162 with a central server (CS) 110. There may be more than one central server 110. Central server 110 has software module 112, communications module 114, management module 116, and memory 118. There may be more than one of each of the modules or additional modules. Software module 112 contains software and programming to manage central server 110 and its functionality. Communications module 114 handles communications between the central server 110 and communications media 162 and 163. The communications module 114 also provides for communications between various devices (not shown) and the central server 110. Management module 116 provides for the various management functions of central server 110. Memory 118 provides for storage of long-term and short-term information and data for central server 110. The target market business structure system including all inputs/outputs may be secured with the use of access control lists and is secured to maximum industry standards.

There are in-store devices 132, 134, and 136 of which there may be more than three. The in-store devices communicate via communications medium 164 with the target market server (TMS) 120. Target market server 120 has software module 122, communications module 124, management module 126, and memory 128. There may be more than one of each of these modules. Software module 122 contains software and programming to manage the TMS 120 and its functionality. Communications module 124 handles communications between the TMS 120 and communications media 163, 164, 166, and 165. The communications module 114 also provides for communications between various devices (not shown) and the TMS 120. Management module 126 provides for the various management functions of TMS 120. Memory 128 provides for storage of long-term and short-term information and data for the TMS 120.

There are member devices 142, 144, and 146, of which there may be more than three, which communicate with the TMS 120 through communications medium 165. The TMS 120 may also communicate with social media 150 through communications medium 166 and the member devices may also communicate with social media 150 through communications medium 167. Social media 150 may be such things as Facebook, Twitter, Linkedln, RenRen, etc.

### The Central Server

The main functions of the central server, the CS, are as follows. It accumulates data regarding products and services for the target market and adapts it to the target market. It creates or helps to create the TMS website which is created to appeal to a target market. It creates a query and response engine for use by consumers accessing the TMS. It accumulates data from sources such as the TMS, in store devices, privilege cards, social media, etc. and provides analytical reports to suppliers based on the various types of accumulated data. The system, for example the TMS, filters the data such that the CS accumulates data which is permitted to leave the target market country according to the rules and regulations of the target market country.

A target market is a market segment of interest to a supplier or suppliers. It may be defined by various combinations of criteria including, but not limited to a particular type of goods or services, consumers interested in a particular type of goods or services (luxury) etc., language, geo location, country, local culture, social customs, consumer income, time of year, season, weather, etc.

The CS collects data and information that is used to create a target market website on the TMS (the TMS website). This data may be obtained by various means. The data may be obtained from suppliers of goods and services via their corresponding supplier systems which in the main are electronic systems, servers, websites, etc. The data may be obtained from other sources which have expertise in the particular market or experts of the particular goods and services such as publishing entities specializing in the target market or the goods and services via their systems which in the main are electronic systems, servers, websites, etc. The data may be obtained by Internet web crawlers. The data may also be obtained by manual entry of data.

The data obtained by the CS includes information regarding the goods and services offered by the suppliers where suppliers are providers of the goods and services for the target market. This may include product information, commonly known as collateral, such as sizes, colors, options, prices, time period during which the product are available at a suppliers store or website. It may include physical store locations where goods or services are available. It may also include descriptions, educational material, and promotional material related to the goods and services. It may include recommendations about other goods or services that relate to a specific good or service. It may include material that may appear in a goods or services brochure, on the supplier website, etc. It may include graphics and copy relating to the goods and services. The obtained data may be associated with placement and advertising plans. These placement and advertising plans enable charging fees for premium placement and display of the goods and services on a target market website. The CS is managed by a central server entity (CS entity) which manages and oversees the creation, operation, management, and functionality of the CS.

At the CS, the received data is compiled and normalized by mapping it into a common format. The CS is instrumental in providing data for the TMS and the corresponding TMS website. The CS may create or update the TMS, provide information that can be used at the TMS to create or update the TMS or any combination of these activities. The CS may also translate the data for the TMS into a language appropriate to the target market and produce the data in a style and format suited to the target market. The CS provides, among other things, the product and market information and knowledge for a TMS. The CS is a sales source to the suppliers and a source of educational material for the TMS. The CS through the CS Entity is close to and understands the Target Market and is in a position to engage with the suppliers of any target market goods. The CS may collect a commission fee from a supplier on sales that result from the efforts of the CS entity. The CS is capable of securely communicating via the various electronic communications media and social media systems. The CS is not intended to allow placement of orders for the goods or services shown, described or written about. No direct sales orders are taken. The CS takes no responsibility to hold inventory or make shipments or delivery of goods or services.

The CS collects data including statistical data received from the TMS pertaining to target market activity compiled at the TMS and stores it in a database configured to provide analysis of the collected data and provide reports pertaining to the collected data. The collected data comprises data which was permitted to be transmitted outside of the target market country. This data may come from consumer interaction at the TMS, in store devices, privilege cards, social media, etc. The CS prepares reports for the suppliers based on this target market activity. The data and reports may be used by the suppliers to track such things as consumer buying patterns, browsing history, searches, measurement of the effectiveness of their advertising efforts, and measurement of the effects of the CS entity efforts in the target markets. The reports may show an entire target market, an individual supplier's data and relative position in the total target market. The reports can also encompass all target markets pertinent to the supplier. The reports may be constructed with blinding restrictions so competitive supplier's cannot discern each other's data but can see only their own data and the entire target market data. Access to the database and reports may be provided to suppliers and others as an online data analysis platform and service allowing ad hoc queries into online content gathering, social influencing, purchasing, and other consumer behavior. Data acquired through the use of the privilege card can be used in sales training activities by suppliers, product portfolio management and marketing program development, to name a few of the many uses.

The online data analysis platform and service is designed to enable a wide range of users with varying technical proficiency to assemble charts and datasets from a variety of locations. The platform is adapted so non-technical users may use it in order to present intuitive graphics and reports allowing easy to read and understand presentations. The platform is accessible over a wide range of communications media such as the Internet, local area networks, wide area networks, directly hardwired, wireless, satellite, etc. Users may connect to the platform using devices connectable to the various types of communications media and may include a desktop computer, laptop computer, tablet, smart phone, personal digital assistant (PDA), etc.

The CS Entity may be responsible for the look, feel, design, language, suitability to the target market, and content of the various TMS websites. The design and content of the TMS website will have inputs from suppliers, the TMS Entity, or any other appropriate source.

The CS has various internal functions, such as general management, management of editorial content, sales, language translation, financial reporting, data analysis, etc. The CS also has enterprise resource planning capability. These capabilities may include a Content Management System (CMS) for managing the data and collateral, storage of financial data, performance of financial analyses, collection and sanitization of consumer data, deep analyses and analytical functionality relating to consumer data, detail trends, demographics, etc. They may also include secure channel communication to TMS and other systems or devices, internal and supplier reporting engines, the handling of transaction data, provisioning and management of in store devices, management of rewards programs, customer relationship management (CRM) functionality, translation functions, and Internal functionality such as human resources, document control, change control, office inventory of the CS entity, etc.

### The TMS Server/Supplier Systems and Other Sources

The target market server (TMS), managed by the TMS entity, is the point of contact for consumers and suppliers via the TMS website. A TMS may have more than one TMS website where each website is designed for a specific target market or submarket. The TMS may be physically located in the geographic location of the target market, outside of the geographic location of the target market, or even be part the CS. Consumers who are granted access to a TMS may become members. Only members are allowed access to restricted or special areas of the TMS website. Members may be restricted to a particular TMS and TMS website or granted access to some or all TMSs and TMS websites. The TMS entity manages and oversees the creation, operation, management, and functionality of the TMS and TMS website. The online data analysis platform and service as described above for the CS may also be accessible on the TMS.

Members may access the TMS website via devices which are connectable to the TMS over electronic communications media, usually the Internet. These devices may be a desktop computer, laptop computer, tablet, smart phone, personal digital assistant (PDA), etc.

The TMS Entity in conjunction with the CS entity, suppliers, and other sources of information is responsible for the look, feel, design and content of the TMS website. The TMS, as described above for the CS, has various internal functions, such as general management, management of editorial content, sales, language translation, financial reporting, data analysis, etc. The CS also has enterprise resource planning capability. These capabilities may include a Content Management System (CMS) for managing the data and collateral, storage of financial data, performance of financial analyses, collection and sanitization of consumer data, deep analyses and analytical functionality relating to consumer data, detail trends, demographics, etc. They may also include secure channel communication to CS and other systems or devices, internal and supplier reporting engines, the handling of transaction data, provisioning and management of in store devices, management of rewards programs, customer relationship management (CRM) functionality, language translation functions, and Internal functionality such as human resources, document control, change control, office inventory of the TMS entity, etc.)

The TMS website is interactive and interacts with the CS, members, social media, in store devices, and other devices (not shown) that may be used to access or manage the TMS. It has a query/search engine, has target market educational content, latest target market information, provides directions and links to supplier's web sites and stores, provides a way for members to contact the supplier and supplier's stores, and is able to make member appointments to see the goods or services of interest to the member at supplier stores.

The TMS makes updates to the TMS website. It incorporates changes from suppliers regarding their offering of goods or services, changes from the other sources of information, changes initiated by the CS entity, supplier changes resulting from analytical reports, changes initiated by the TMS entity. The changes based on the analytical reports may be related, but not limited to social media interaction, member browsing history, member searches, member purchases, and member appointments.

The TMS is a local base in the target market that speaks the language and understands the culture and customs of the target market and provides local contact for business dealings in the target market country or market. The TMS adapts the information presented about the goods or services to the target market by conforming to target market language, social customs, etc. The potential consumers may or may not be familiar with the particular goods or services. They may not yet be knowledgeable about the specifics of the particular goods or services they want. The CS and TMS entities are knowledgeable about what particular goods or services the target market wants and can present it to them in a manner consistent with their culture, in their language, etc. The system and method function as a source of information and education about these particular goods or services. This is the educational aspect of the system and method. The system and method “speaks the target market consumer's language,” both figuratively and literally, and presents information in a manner to which the target market can easily relate.

TMS entity may collect a commission fee from the supplier on sales that result from the efforts of the TMS entity where the supplier is located within the target market country. In another example, where the supplier is located outside of the target market country, the commission is paid to the CS entity from the supplier.

The TMS gives suppliers the ability to directly influence consumers. Consumers can book an appointment at the supplier's store via the TMS. Supplier staff may add personal recommendations, notice of promotions, etc. Suppliers get near real-time feedback for appointments and can act accordingly in preparation for the consumer's arrival. Personal relationship may be bolstered by text messages, alerts, etc. The store staff may communicate with the consumer through the TMS. The supplier may keep a blog on the TMS. Interaction with social media and members can be part of the blog content where links may be embedded in the blog. Blogs may be maintained by suppliers or the TMS entity.

The TMS provides a social media network for the target market. Such social networks as Twitter, Face book, Linkedln, and others, such as the Chinese Renren, may be used to communicate about the target market as appropriate to stimulate interest and to help encourage visits to the supplier's internet web sites and stores

### The Privilege Card

The TMS provides members with a privilege card, the card. The card may be used by members at supplier stores, supplier web sites, other venues, or at special events or benefits. The Card may contain either by printed, magnetic, optical or by other means the member name and relevant information. The card may be a smart card. The card may be integrated into a near field communication (NFC) device, such as a smart phone allowing the functionality of NFC devices. The card may be stored within an “app” or application on a smart phone or other electronic or mobile device.

The Card will also provide means of recording where it is used. Information recorded on the card is transmitted to the TMS and at least some of it remains stored on the card. The card has the ability to accumulate points or other rewards for the member when presented to the supplier or at other special events. For the target market the card will be promoted as very special or exclusive and may have a price tag or may be provided in various value levels such silver, gold, platinum. The card is the member's key to special treatment, perks and access to events such as shows, new goods or services introductions, etc. These events may not be otherwise accessible or available for purchase. It may be used as a discount card by suppliers. It may also be a credit card.

The card need not be limited to a specific target market location. It may also be used worldwide. Incentives are provided. Points may be accumulated for use of the card allowing the receipt of rewards. The rewards may be monetary or non-monetary such as participation in events to which access is restricted and not for sale. These restricted events may be fashion demonstrations, access to an owner's box at sporting event, access to a movie shoot, etc.

The TMS, as with the CS, does not place orders for the goods and services shown, described, or written about. No direct sales orders are taken. There is no responsibility to hold inventory or make shipments or delivery to the consumer. This ensures that the consumer buys directly from the supplier and not a third party which may be unreliable thus reducing the risk of buying counterfeit goods.

Member incentives to use the card and the TMS may include access to a TMS and TMS website, access to all TMSs and TMS websites, possession of the card, access to educational information regarding the goods and services, VIP levels allowing access to events and perks, making appointments with stores, interactive games relating the goods and services of the target market the playing of which may increase rewards.

### Social Media

The members, TMS, and in store devices may be used to access social media. The social media may be such media sites as Facebook, Twitter, Linkedln, RenRen, etc. The TMS entity may monitor social media sites, blogs, Internet news etc, gaining knowledge about what goods or services have been exposed, goods or services in which an interest has been expressed, if a celebrity is using it, etc. Social media sites record data pertaining to usage of the sites, such as hashtags, trending topics, indexing, recording of searches, and more. This recorded data may all be accessed and stored at the TMS and used in analytical reports. The social media may also be used to broadcast messages to members regarding the suppliers or their goods and services to communicate purchases to friends.

### In Store Devices

Devices, in store devices, are located in supplier's stores. The in store devices may be a smart device such as an iPad, smart phone, tablet, PDA, laptop computer, desktop computer, etc. The in store device may be independent of, connected to, or integrated as part of the store cash register system. The in store device may be equipped with a dongle for security, or a card reader for recording a member's card, interfacing through sound jack or multi wire port. The in store device may be keyed to a store sales person for tracking purposes. Various methods of keying the device to a sales person may be having each sale person having their own device, a shared device requiring passwords, etc. The device is connectable to communications media by wired or wireless means.

The in store device may be able to interact with an NFC device which functions as the card. It may be capable of wireless electronic communication and able to communicate with the CS or TMS and transfer information to or from the CS or TMS. It may be able to take or record photographs, display the TMS website, enter and record sales information, enter and record sales clerk information, enter and record other information required for consumer support and business needs. The in store device may be able to record images taken by other devices. The in store device is able to place watermarks on photos as a type of “proof of purchase” for members which may be communicated to other members or used for insurance records. The in store device may be used to communicate with a member via the TMS. This communication may include electronic methods of communication such as text messages, Tweets, emails, etc. It may also be used to maintain a Blog on the TMS.

The in store device may be used to confirm member appointments and access member information from the TMS prior to an appointment such as consumer preferences, sizes, recent purchases, card level, etc. The in store device may have access to the TMS website for review of supplier goods and services. It may be used to track employee sales data and incentives, send thank you notes to a member after visiting the store or making a purchase either directly or via the TMS.

### Commission Payments

Commission payments to the CS entity or TMS entity may be made for member purchases including but not limited to: the CS entity may receive a commission from the supplier for purchases made outside of the target market such as on the supplier website, the TMS entity may receive a commission from the supplier store for purchases made in a store located in the target market.

### Analytical Reports

Data recorded at the TMS is sent to the CS where analytical reports are prepared and sent to suppliers. The supplier can get immediate feedback on the sales process. The supplier can profit from pre-manufacturing input from consumers. The supplier can determine what is or is not selling and adjust production of goods or offering of services accordingly. The supplier can determine what part of the life cycle their goods and services are in: Is the product old and dated or new to the market. The reports can provide real-time sales data from in-store devices on which products are generating interest. Provide analysis of source data from social media activity for supplier business management. Provide analysis of source data from web searches and browsing on the TMS. Provide total industry wide data on sales, browsing and searching, social media for supplier business management. In addition, the reports may be just for a single target market or any combination of target markets.

The reports etc. may be accessed via the online data analysis platform and service as described above for the CS and TMS.

The types of reports may include such types as number of online inquiries, number of unique online inquiries, time spent on web site by each member, number of members, number of return member inquiries, number of supplier sites visited, which supplier sites are visited, products visited per member, number of appointments made, what stores and store locations got appointments, appointments per product, where appointments were made, sales per appointment (number and dollar value), sales per inquiry, online sales per visit, product sold attributes (color, size, style, price, etc.), member buying trends and forecasting analyses, purchases per featured item, purchases per reward levels associated with the privilege card, total market/sales per product class, member profiles (age, gender, income, location, buying habits, spending volume), product return data, each vendor percentage of total market, social media activities, provide real time data to vendors for media campaign analysis, data on special orders, inventory control cross check, privilege card member event tracking and so on.

### Examples

As will be described in further detail below, the CS entity gathers information regarding goods and/or services offered for sale by multiple vendors and feeds selected product and advertising information to different TMS entities, each TMS entity located in a different target market country. Each TMS entity is responsible for the look, feel design and content of a TMS website in its own target market country. The TMS website in the target market country has information that is tailored to meet the specific needs of the target market consumers in the country. For example, information regarding high end luxury goods or the current fashion trends in a particular country may be presented. The information may also be presented in a manner which takes into account the target market country culture and customs. The TMS website delivers the tailored information to selected “club” customers, inviting them to specific stores in the target market country that sell the goods and/or services. When a sale is made, the CS entity receives a commission from the vendor who made the sale. This hierarchical arrangement including the partitioning of the TMS websites from the CS entity directs consumers in different demographic or geographical areas or economic conditions towards specific stores for specific merchandise that is highlighted for their demographic area or economic conditions.

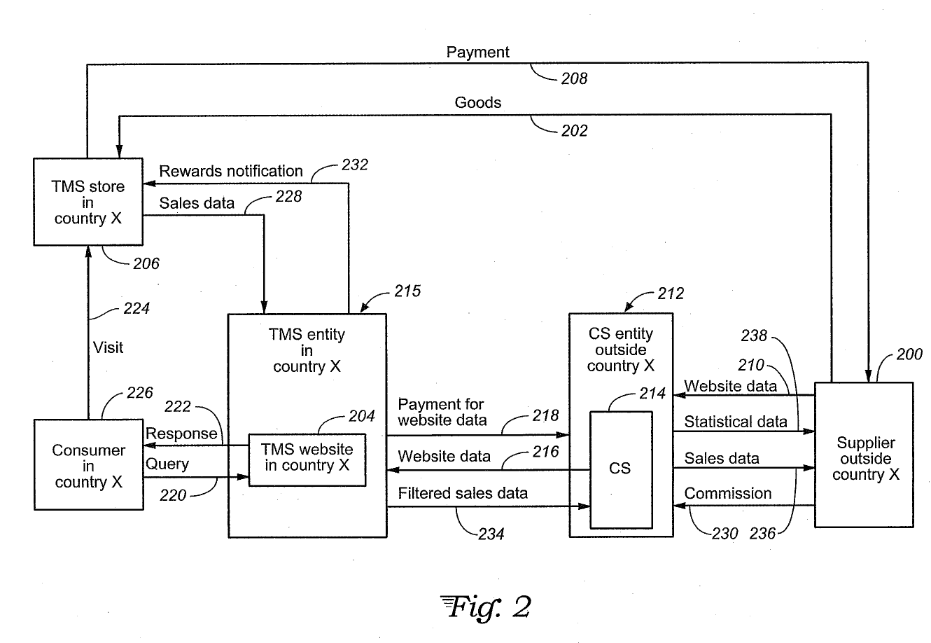

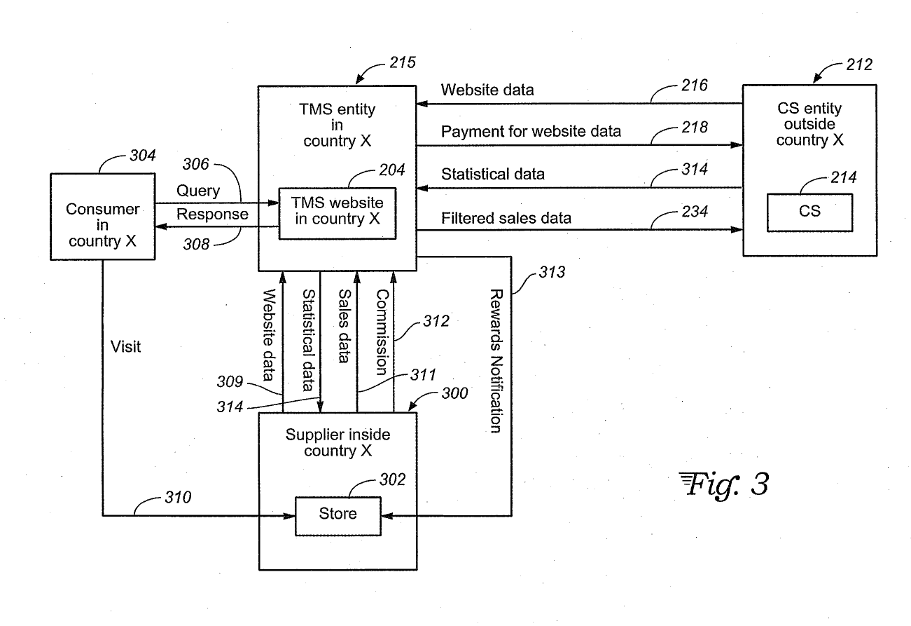

With reference to FIGS. 2 and 3, TMS entity 215, which may be owned and operated by CS entity 212, receives website content data from multiple suppliers/vendors including, for example, supplier 200 located outside of target market country X and supplier 300 located within target market country X which is used to create a TMS website 204 that delivers tailored information regarding goods and/or services to selected “club” customers, inviting them to specific stores within the target market country. Supplier 200 provides website data 210 to the CS entity 212. CS entity 212 transmits website data 216 including website data 210 and/or additional data to TMS entity 215 where, with other data such as website data 304 from supplier 300, it is used create TMS website 204. TMS entity 215 is located within the target market country and has a target market server TMS (not shown) and a TMS website 204. CS entity 212 may be located in the United States or in a country other than target market country X and includes central server CS 214.

Where the supplier is located outside of the target market country X, CS entity 212 receives website data 210 from the supplier 200, for example selected advertising and goods/services information, and transmits website data 216 to the TMS entity 215 within target market country X. Where the supplier is located within the target market country, the supplier 300 feeds website date 309, for example select advertising and goods/services information, directly to the TMS entity 215. Payment 218 for the website content data may be provided from TMS entity 215 to CS entity 212. Payment for the website content data may be provided to TMS entity by the supplier 300 located within target market country X. The website content data may be collected from other sources.

In a preferred embodiment, multiple suppliers outside of and/or within a target market country are included in the target market business structure to offer a multitude of goods and services for sale on a TMS website. The more types and brands of goods and services of multiple suppliers being offered on the TMS website, the more likely it is that the TMS website will become a popular site among consumers in the target country.

Goods from different suppliers may be provided to the same or different stores in the target market country. In FIGS. 2 and 3, suppliers 200 and 300 provide goods to the target market stores, 206 and 302, respectively. The TMS store 206 in country X is billed by the shipper for the goods and the TMS store 206 in country X provides payment 208 to the shipper/supplier 200 for the goods using traditional means including negotiable shipping documents.

Consumers, for example consumers 226 and 304 access TMS website 204 to browse and become educated about goods and services offered for sale. The website 204 accepts consumer queries 220 and 306. The TMS website 204 provides responses 222 and 308 to the queries by, for example, making an appointment for the consumer for a visit 224 at the TMS store 206 in country X, making an appointment for the consumer for a visit 310 at the TMS store 302 also in country X, by processing an online purchase of the goods or services or by providing specific information about the goods or services.

If consumers 226 and 304 purchases goods or services from a TMS store, for example TMS store 206 or 302 in country X, information regarding the purchase, or sales data 228 and 311 is provided to the TMS entity 215. With regard to the supplier 200 located outside of country X, filtered sales data 234 including information indicating that a purchase was made, is provided to the CS entity 212 from the TMS entity 215. The sales data which is filtered out is dependent upon the particular rules and regulations of country X such that the data transmission conforms to country X's particular financial and legal rules as well as the rules of the CS entity's country. For example, for a CS entity located in the United States, filtering would make sure that no rewards were paid to a merchant who was also a government official in country X in possible violation of the Foreign Corrupt Practices Act. CS 214 provides sales data 236 based on the filtered sales data 234 to the supplier 200 who then provides a commission 230 to the CS entity 212 because a consumer made a purchase resulting from the efforts of the CS entity and/or the TMS entity.

With regard to supplier 300 located within country X, the sales data 311, including information indicating that a purchase was made, is transmitted to the TMS entity 215. Because this information is not being transmitted out of the country, filtering is not required. The supplier 300 then provides a commission 312 to the TMS entity 215 because the consumer made a purchase resulting from the efforts of the CS entity and/or the TMS entity.

A consumer may also make a direct purchase of goods or services from the TMS website 204. The CS entity 212 would then receive a commission 230 as with a traditional affiliate program.

Sales data may be used to track employee sales and employee reward notifications 232 and 313 may be provided to the TMS stores 206 and 302 in country X, respectively, indicating that the employees who made the sale are entitled to receive rewards or incentives such as tickets to an event or travel vouchers.

Sales data 311 and 228 and other data recorded by the TMS entity 215 may be filtered and sent to CS entity 212 as a part of the filtered sales data 234 where it may be used to prepare statistical data 238 and 314 for suppliers 200 and 300, for example requested reports pertaining to target market activity.

What is claimed is:

1. A computerized method for billing a commission comprising:
gathering at a first server, data relating to the offering for sale of goods or services of at least one supplier of goods or services;
adapting the gathered data as presentation data and transmitting the presentation data to a second server via a global network, the second server located in a target market country;
receiving the presentation data at the second server and communicating with consumers in the target market country with a website presenting at least some of the presentation data;
accepting consumer queries on the website;
responding to the consumer queries by making a consumer appointment to a target market country store associated with the at least one supplier of goods or services by the second server communicating with an in store electronic device via the global network, the in store electronic device being physically located in the target market country store associated with the at least one supplier of goods or services in the target market county;
transmitting information about a purchase made by the consumer at the target market country store associated with the at least one supplier of goods or services from the in store electronic device to the second server via the global network; and
billing the at least one supplier of goods or services for the commission payment for the purchase made by the consumer at the target market country store associated with the at least one supplier of goods or services.

2. The method of claim 1, wherein the first server and the at least one supplier of goods or services are located outside of the target market country.

3. The method of claim 2, further comprising transmitting the information about a purchase made by the consumer at the target market country store from the second server to the first server.

4. The method of claim 3, further comprising filtering at the second server information about a purchase made by the consumer at the target market country store prior to transmitting the information about a purchase to the first server.

5. The method of claim 2, further comprising transmitting data relating to the offering for sale of goods or services of a second supplier located in the target market country directly from the second supplier to the second server located in the target market country, receiving the data relating to the offering for sale of goods or services of the second supplier located in the target market country at the second server and communicating at least some of the data relating to the offering for sale of goods or services of the second supplier with consumers in the target market country with the website.

6. The method of claim 5, further comprising:
accepting consumer queries on the website;
responding to the consumer queries by making a consumer appointment to a target market country store associated with the second supplier of goods or services by the second server communicating with an in store electronic device via the global network;
transmitting information about a purchase made by the consumer at the target market country store associated with the second supplier of goods or services from the in store electronic device to the second server via the global network; and
billing the second supplier of goods or services for the commission payment for the purchase made by the consumer at the target market country store associated with the second supplier of goods or services.

7. The method of claim 6, further comprising transmitting statistical data from the second server to the second supplier of goods or services located in the target market country.

8. The method of claim 3, further comprising creating statistical data at the first server from the transmitted information.

9. The method of claim 8, further comprising transmitting the statistical information from the first server to either the first or second supplier or both the first and second suppliers.

10. The method of claim 1 further comprising the at least one supplier shipping goods to the target market country store and the target market country store providing payment to the supplier for the goods.

11. The method of claim 1, wherein responding to the consumer queries includes processing an online purchase on the website by the consumer and further comprising billing the at least one supplier of goods or services for the commission payment for the online purchase made by the consumer.

12. A method for billing a commission comprising:
gathering at a first entity information relating to the offering for sale of goods or services of at least one supplier of goods or services;
transmitting the information to a second entity located in a target market country;
receiving the information at the second entity located in a target market country and communicating the information to consumers in the target market country with a website offering for sale goods or services of at least one supplier of goods or services accessible in the target market country;
accepting consumer queries on the website;
responding to the consumer queries by making a consumer appointment to a services target market country store associated with the at least one supplier of goods or services;
transmitting information about a purchase made by the consumer at the target market country store from the target market store to the second entity;
transmitting information about a purchase made by the consumer at the target market country store from the second entity to the first entity;
transmitting information about a purchase made by the consumer at the target market country store from the first entity to the at least one supplier of goods or services; and
billing the at least one supplier of goods or services for the commission payment for the purchase made by the consumer at the target market country store associated with the at least one supplier of goods or services.

13. The method of claim 12, wherein responding to the consumer queries including processing an online purchase made with the website.

14. The method of claim 12, wherein the first entity includes a central server outside of the target market country.

15. The method of claim 14, further comprising filtering the information about a purchase made by the consumer at the second entity and transmitting the filtered information to the first entity.

16. A merchandising system comprising:
a central server in a first country receiving merchandise information from a plurality of vendors, the central server tracking purchases from stores in one or more target market countries;
at least one target market country server in communication with the central server and receiving selected merchandise information from the central server;
a plurality of buyers in the target market country in a membership group having access to the target market country server, the stores in the target market country having electronic devices for making buyer appointments for viewing merchandise and for reporting purchases to the target market country server; and
the target market country server having means for filtering purchase information and reporting filtered purchase information to the central server.

17. The merchandising system of claim 17, wherein the target market country server has means for transferring funds in payment of the selected merchandise information received from the central server.

18. The merchandizing system of claim 17, wherein the target market country server has storage for buyer merchandise preferences.

19. The merchandising system of claim 17, wherein the central server has means for tracking orders and shipments of merchandise.

20. The merchandising system of claim 17 where the central server has means for creating statistical data from filtered purchase information.
